(19) United States
(12) Patent Application Publication
(10) Pub. No.: US 2019/0211592 A1
(43) Pub. Date: Jul. 11, 2019

(54) Acquisition System for Detection of an Actuation in a Handle Device of a Vehicle

(71) Applicant: HUF HÜLSBECK & FÜRST GMBH & CO. KG, Velbert (DE)

(72) Inventor: Hubert Bextermöller, Mülheim an der Ruhr (DE)

(21) Appl. No.: 16/328,232

(22) PCT Filed: Aug. 15, 2017
(86) PCT No.: PCT/EP2017/070671

§ 371 Date: Feb. 25, 2019

(30) Foreign Application Priority Data
Aug. 23, 2016 (DE) 10 2016 115 570.5
Sep. 5, 2016 (DE) 10 2016 116 579.4

(51) Int. Cl. E05B 85/10; E05B 81/76

(52) U.S. Cl. CPC E05B 85/107; E05B 81/76; E05B 85/103

(57) ABSTRACT

The invention relates to an acquisition system (200) for the detection of an actuation in a handle device (10) of a vehicle (1), comprising a movement device (20) for the movement of a handle part (11) of the handle device (10) from a resting position (I) to an operating position (II), wherein the movement device (20) can be brought to a first motion course (A) to cause the movement of the handle part (11), and, after completed conduction of the first motion course (A), can be brought into a second motion course (B).

The present invention relates to an acquisition system for the detection of an actuation in a handle device of a vehicle according to the type further defined in the preamble of claim 1. Furthermore, the invention relates to a handle device according to the preamble of claim 5, and to a method for the detection of an actuation of a handle device according to the preamble of claim 15.

It is known to use sensors for the detection of an actuation in a handle device from the prior art. The sensors, such as mechanical or capacitive sensors and the like, can be arranged on or in the handle part of the handle device in order to detect an actuation of the handle device. For example, a contact can be detected by the sensors, in order to thereby recognize the actuation of the handle device. This detected actuation usually leads to an activation of a closing device of a vehicle and/or to the initiation of an authentication process.

However, it turned out to be a disadvantage that the detection of the actuation can be complicated by interfering impacts. These interfering impacts are e.g. movements, such as shearing forces or heat-related expansions, which are particularly relevant for mechanical sensors, or weather-related influences (humidity and the like), which have a negative effect in particular on capacitive sensors. Measures for preventing and/or reducing erroneous detections of the actuation are often complex in construction and involve high costs.

Therefore, it is an objective of the present invention to at least partially resolve the above-described disadvantages. In particular, it is an objective of the present invention to provide a more cost-efficient and/or simpler and/or more reliable detection of the actuation in a handle device possible. Furthermore, it is in particular an objective to be able to conduct a detection, in particular query, of the actuation that complies with a high security standard.

The above object is achieved by means of an acquisition system having the features of claim 1, by a handle device having the features of claim 5, as well as by a method having the features of the independent method claim. Further features and details of the invention result from the respective dependent-claims, the description and the drawings. Features and details described in conjunction with the acquisition system, according to the invention of course, also apply in conjunction with the handle device according to the invention as well as the method according to the invention, and in each case vice versa, so that, in terms of the disclosure, reference is or can always reciprocally be made to the individual aspects of the invention.

The object is in particular achieved by means of an acquisition system for the detection of an actuation in a handle device of a vehicle.

In particular, the acquisition system according to the invention includes a movement device, which upon a movement of a handle part (e.g. door handle) of the handle device can be brought into at least one actuation motion course. The motion course of the movement device can, in this case, be caused by the handle part and/or by a drive device, and preferably has an influence on the movement of the handle part. For this purpose, the movement device particularly comprises at least one bearing means and/or lifting bearing and/or guiding means and/or gear mechanism and/or the like for the handle part, or for the movement of the handle part.

Preferably, the movement device serves to move the handle part of the handle device, in particular from a resting position to an operating position, and/or from the operating position to an actuation position, preferably in an active and/or passive manner. In particular, the movement device is brought into the actuation motion course to cause the movement of the handle part, preferably in that the movement of the handle part is transmitted to the movement device. To cause the movement of the handle part, the handle part is e.g. mounted by means of the movement device around a handle part axle, in particular handle part rotary axle. The mounting is e.g. effected by means of at least one movement element, in particular a second movement element, of the movement device.

Preferably, the movement device can be brought into a first motion course A and into a second motion course B, wherein preferably the second motion course B corresponds to the actuation motion course. In particular, the movement device can only be brought into the second motion course when the first motion course has been completely conducted.

Preferably, a resting position is provided, in which the handle device cannot be actuated. This comes with the advantage that a particularly high operational convenience can be created. Thus, the handle part is arranged flush in the car body or in the movable part, such as a door, in the resting position, and is extended into the operating position by means of a drive device, or the movement device, e.g. upon detection of the approach of the user.

Furthermore, it can be possible that an operating position (or first operating position), is provided, in which the handle device can be actuated. Furthermore, an actuation position (or second operating position) is provided, in which the handle device is actuated (e.g. by pressing or pulling on the handle part). It can be possible that the operating position be the (only) initial position of the handle part, and thus a separate resting position is allotted. This provides a particularly simple and cost-efficient configuration of the handle device. Alternatively, the resting position is provided, and the handle part can be brought, in the first motion course, from the resting position to the operating position.

It is provided here that at least one actuation detection element is arranged on the movement device, so that preferably the actuation motion course can be assessed by means of a detection of the actuation acquisition element, whereby in particular the actuation (of the handle part) can be detected. This achieves the advantage that an especially simple and reliable detection of the actuation is provided. By means of the arrangement in the movement device, which serves e.g. to support the handle part, a particularly reliable detection is possible. In the case that a resting position is provided, actuation of the movement from the resting position of the handle device can be differentiated in a simple and cost-efficient manner as well. Furthermore, the arrangement of the actuation acquisition element in the movement device in particular ensures that movement phases of the handle part can be assessed in a very differentiated manner, e.g. for error diagnosis.

The handle part is configured e.g. as a movable, in particular rotatable and/or pivotable door handle for a movable part, in particular a door, of a vehicle. In this case, the movement device can include at least one gear mechanism element or the like, in order to transmit at least one movement.

The vehicle is e.g. configured as a motor vehicle and/or passenger motor vehicle and/or electric vehicle and/or as a self-driving (autonomous) vehicle.

It is preferably provided that the movement device can be brought into a first motion course, in particular by means of a drive device, in order to cause, i.e. in particular transmit and/or generate, the movement of the handle part, and after (in particular completed) conduction of the first motion course, can be brought into a second motion course, i.e. actuation motion course, in particular (manually, or) by means of the handle part. The drive device can be at least partially configured separately from the movement device or at least partially be part of the movement device. This provides the advantage that an automated movement from the resting position to the operating position is made possible. Alternatively (e.g. when no resting position, separate from the operating position, is provided for), or additionally, it can be possible that the movement device in the (second) motion course or in the actuation motion course serves to guide and/or influence the movement of the handle part. For example, a (second) movement element of the movement device is configured as a bearing arm or mounting means or the like for the handle part, for this purpose.

Preferably, the movement device includes at least one movement element. In particular, a first movement element and/or a second movement element is provided, wherein preferably the first movement element is used only for the first motion course, and in particular preferably the second movement element is moved both in the first and in the second motion course. Preferably, the first movement element is part of the drive device, e.g. a motor, preferably a servo motor or a stepper motor, or a shaft (drive or output shaft). It can also be possible that the drive device is configured as a motor that includes the first movement element, e.g. as a shaft. In particular, a comparison acquisition element can also be integrated in the drive device, in order to recognize the movement of the first movement element in a particularly simple and compact manner.

It can advantageously be possible that a first motion course A and/or a second motion course B are provided, which preferably are different from one another. The actuation motion course in particular is the second motion course. In the first motion course, the movement device displaces the handle part e.g. from a resting position to an operating position and/or vice versa. In the second motion course, the movement device and/or a user manually, displaces the handle part e.g. from the operating position to an actuation position and/or vice versa. In particular, a (manual) exertion of force on to the handle part is effected for this purpose, e.g. a pulling or pushing, preferably in the direction of the movable part, or in the reverse direction and/or laterally thereto. It can also be possible that a first movement of the handle part from the resting position to the operating position (and/or vice versa) is effected automatically and/or a second movement of the handle part from the operating position to the actuation position (and/or vice versa) is effected manually. The first movement preferably occurs in the first motion course, and is preferably initiated dependent upon an approach of a user to the handle device. The second movement preferably occurs in the second motion course or actuation motion course, and is preferably initiated manually by the user, preferably around a movable part of the vehicle. Of course, it can be possible that a resting position, apart from the operating position, can also be disposed of, and thus in particular only the second motion course (without the first motion course) is provided. This provides a particularly simple construction of the handle device.

Moreover, it is advantageous if the movement device comprises at least one movement element, which is movable around a rotary axle, wherein the movement of the movement element, in particular a rotary movement, can be detected by means of the actuation acquisition element, wherein preferably the rotary axle corresponds to a handle part axle or is configured at a distance from the handle part axle, wherein preferably the movement of the movement element depends on the movement of the handle part. This provides the advantage that the actuation of the handle device can be detected in a simple manner. In particular, for this purpose, a movement of the handle part is detected, preferably indirectly via the movement of the movement element. The actuation acquisition element is e.g. arranged in the region of the rotary axle and/or handle part axle. This allows an especially dependable and construction-simple detection of the movement. The handle part axle in particular is the rotary axle, around which the handle part rotates or around which the handle part is pivoted.

Preferably, it can be provided in the scope of the invention that the actuation acquisition element is arranged in the region of a rotary axle, and/or is oriented toward at least one movement element, in particular second movement element, of the movement device, in order to detect a movement of the movement element, in particular around the rotary axle, wherein preferably the movement of the movement element is specific for the actuation motion course (and/or depends on the actuation motion course), and preferably the actuation motion course is at least partially specific for the actuation in the handle device (and/or depends on the actuation). Accordingly, the movement device is adapted in such a way that, in a simple way, the actuation of the handle device, i.e. in particular the manual exertion of force on the handle part, can be detected based upon the movement of a movement element. The actuation acquisition element is e.g. arranged on the movement element, or arranged outside thereof, and/or arranged on the handle part, or arranged outside the handle part.

In particular, it can be possible that the actuation acquisition element is arranged fixedly and/or non-movably and/or rigidly in the handle device, preferably connected rigidly with a housing and/or a circuit board of the handle device. Alternatively or additionally, a movement of the actuation acquisition element is independent of the movement/actuation of the handle part. For this purpose, the actuation acquisition element preferably is arranged in a rotary axle or in the region of a rotary axle of the (second) movement element. Since the (second) movement element preferably directly depends on a movement of the handle part upon the actuation, the actuation can thus be detected in a fail-safe manner by means of the detecting of the actuation acquisition element. Preferably, the rotary axle corresponds to the handle part rotary axle, or is configured at a distance therefrom. In the latter case, the movement element e.g. is configured as a gear mechanism element for the handle part movement.

In another option, it can be provided that the movement device can be brought into a multi-stage motion course, wherein preferably the movement device, in particular to cause a first movement of the handle part and/or to shift the handle part from a resting position to an operating position, can be brought into a first motion course, and preferably after, in particular complete, conduction of the first motion course, can be brought into the actuation motion course as a second motion course, in particular by the actuation and/or manual movement of the handle part, wherein at least the second motion course can be assessed by means of the detecting of the actuation acquisition element. The multi-stage motion course allows here, for example, that a resting position can be provided, in which the handle part is e.g. arranged flush with the outer side of the vehicle body. This allows an improvement of safety and convenience. It is naturally also conceivable that only a single-stage motion course is provided, e.g. only the actuation motion course.

It is further conceivable that upon an actuation, the handle part can be moved from an operating position to an actuation position, so that in the actuation position, the handle part is used for a simple and comfortable opening of a movable part of the vehicle. The movable part in this case is configured as a door or trunk lid or the like, for example.

It can likewise be possible that the movement device comprises at least a first movement element and at least a second movement element, wherein a first movement of the first movement element is specific to a first motion course, and a second movement of the second motion course and/or a comparison of the first movement with the second movement is specific to the actuation motion course as a second motion course and/or the actuation in the handle device, wherein preferably the actuation acquisition element is configured in order to detect the comparison and/or the second movement, and, in particular, the assessment device conducts the comparison. The assessment device is e.g. configured as an electronic assessment device, and includes e.g. a processor or the like. In particular, the comparison allows an error confirmation, in particular a redundant verification, of at least a part of the motion courses. For example, the comparison may also serve to conduct a calibration for the detection of the actuation. In this way, e.g. the precision, with which the first motion course is differentiated from the second, can be increased.

Furthermore, it is conceivable that the actuation acquisition element is connected with an assessment device, so that, based upon the recognition of the actuation acquisition element, a first motion course of the movement device can be differentiated, preferably assessed, from the actuation motion course as a second motion course of the movement device by means of the assessment device. The assessment device comprises at least one electronics component and/or is at least partially configured as an electronic circuit, preferably integrated circuit. This allows a fast and simple detection, as well as in particular an error confirmation.

Likewise subject-matter of the invention is a handle device for a movable part of a vehicle. In particular, the handle device, in particular a handle part, serves to open the movable part, in particular a door or trunk lid of the vehicle or the like. Furthermore, in particular a movably-mounted handle part and a movement device are provided. In this case, the handle part is e.g. movably-mounted in a handle part axle.

It can be possible here that the handle part is manually actuatable in an operating position, so that upon the actuation, at least one actuation motion course of the movement device occurs. For this purpose, an exertion of force occurs on the handle part, preferably by a hand of a user.

The movement device can e.g. be or include the mounting of the handle part, e.g. a bearing arm of the handle part or the like. Furthermore, a movement element of the movement device can e.g. be the bearing arm. Accordingly, the movement device, in particular a (second) movement element, can likewise be at least partially configured in one piece and/or configured monolithically and/or rigidly with the handle part. This makes a secure transmission of force to the (second) movement element and a detecting of the movement possible.

It is preferably provided here that at least one actuation acquisition element is arranged on the movement device, so that the actuation motion course can be assessed by means of a detecting of the actuation acquisition element, whereby the actuation (of the handle part) can be detected. As a result, the handle device according to the invention provides the same advantages that have been described in detail with respect to an acquisition system according to the invention. Moreover, the handle device according to the invention can comprise an acquisition system according to the invention.

Furthermore, it is optionally provided that the movement device comprises at least one movement element, in particular a first and second movement element, wherein at least one of the movement elements is configured as at least one of the following elements:
a movably-mounted, preferably rotatably- and/or pivotably-mounted (in particular non-translatory or stationary but rotatably and/or pivotable) mounting element, in particular a bearing arm of the handle part,
a rotatably-mounted element, in particular a gear or lever, on a fixed axle of the movement device,
a rotatably-mounted shaft,
a drive element, preferably of a drive device.

For example, at least one sensor means can be provided here, in order to detect the movement of the movement element, e.g. a rotary angle or the like. This makes an especially simple and cost-effective configuration of the detection of the actuation possible.

It can be an advantage, in the scope of the invention, if, apart from the actuation motion course, a first motion course of the movement device upstream (or downstream) of the second motion course is provided as a second motion course, so that preferably only the second motion course of the movement device occurs upon actuation (in the normal case), and the first motion course can be differentiated from the second motion course by means of the detection. In particular, in the case of an error in the actuation, the first motion course can also occur at least partially. In other words, in the case of error, a movement of a first movement element may also occur upon the actuation, and, in the normal case, only a movement of a second movement element may occur upon actuation. In this way, a case of error can be identified in simple manner.

Moreover, it is conceivable in the scope of the invention that the movement device comprises a drive device for the handle part, wherein a first movement can be transmitted to the handle part by means of the drive device, so that a first motion course of the movement device occurs, which is different from the actuation motion course. In particular, the first motion course serves to actively move the handle part by means of the movement device. Preferably, in the second motion course, a passive movement of the movement device occurs. Thus, the (manual) actuation can be reliably differentiated from the active movement.

It is conceivable that a movement element, in particular a first or second movement element, is in operative connection with the handle part, so that an in particular second movement of the handle part in the actuation motion course, in particular as a second motion course, can be transmitted to the in particular second movement element, and preferably even a first movement in a first motion course can be transmitted to the in particular second movement element, so that the transmitting movement can be recognized by means of the actuation detected element. This allows it in particular also to verify the first motion course in a redundant fashion, and/or to detect the second motion course by means of the comparison in an especially reliable manner.

It can furthermore be possible that a movement element, in particular a first or second movement element, is connected with the handle part in a rigid and/or co-rotational and/or non-displaceable manner and/or in one piece and/or monolithically. Preferably, the movement element, in particular the first or second movement element, is configured as a part of the handle part. Thus, the actuation can be detected by simple constructional ways. As used herein, the term “co-rotational” particularly means that the corresponding movement element co-rotates along with the handle part, in particular around the handle part rotary axle.

It is optionally also conceivable that a drive device and/or a first movement element is in connection with the handle part for the transmission of force only in a first motion course and/or exclusively form-fittingly and/or force-fittingly, wherein the first motion course is different from the actuation motion course. As a result, in particular a (mechanical) decoupling can be caused, so that the (manual) actuation only causes the second motion course, and the automatized active movement of the handle part by the movement device only comprises the first motion course.

It is also advantageous when a comparison acquisition element is provided, which is configured as a control device for a drive device to cause a first motion course, so that based upon, in particular a comparison, of first acquisition information of the comparison acquisition element and a second acquisition information of the actuation acquisition element, the first motion course and/or the actuation motion course can be assessed. In particular, the comparison acquisition element can also be integrated in the drive device, for example as a sensor or controller or control device or the like. This allows a simple comparison of the motion courses.

Furthermore, it can be provided in the scope of the invention that the movement device comprises a drive device, in particular a motor, wherein the drive device comprises at least one first movement element, so that a drive movement occurs by means of the first movement element, and preferably can be transmitted on to the handle part as a first movement in a first motion course, and in particular indirectly, in particular via the handle part, can be transmitted to a first or second movement element of the movement device. In this way, e.g. for the detection or errors, and/or redundantly and/or ASIL-conform, the first motion course can be identified both by means of a comparison acquisition element and by means of an actuation acquisition element.

It is conceivable that a first movement element of the movement device can be brought in operative connection with the handle part via a transmission element, so that a first movement in a first motion course can be transmitted from the first movement element to the transmission element, and then to the handle part, wherein the first movement in the first motion course and a second movement in the actuation motion course as a second motion course can be transmitted from the handle part to the second movement element, wherein a decoupling element is provided, in order to compensate for and/or prevent and/or change a transmission of the second movement of the handle part to the first movement element.

Optionally, it can be provided that the handle part, in a resting position, is arranged flush with the outer side of the movable part, in particular a car body and/or a door panel, and, in the operating position, protrudes from the outer side of the movable part in a projection-like manner, so that a manual actuation, in particular a movement, of the handle part can be conducted by a user of the vehicle. This provides a significant increase of the operating convenience.

In addition, it can be advantageous in the scope of the invention that at least one movement element of the movement device is provided, in particular a first and/or second movement element. Preferably, the (first and/or second) movement element can in each case be configured as a translatory-fixed (i.e. stationary, but rotatable) part of the handle device, so that preferably a translatory movement of the respective movement element is at least essentially prevented by means of the movement of the handle part. In particular, the respective movement element, preferably only the second movement element, is configured as a (translatory) fixed axle and/or translatory-fixed rotatable and/or pivotable shaft or the like. This provides an especially fail-safe detection of the actuation, since disturbing influences can be reduced due to the (translatory) fixed configuration.

The expression “fixed” relates in particular to the (stationary but rotatable) arrangement in the handle device, “fixated” thus relates in particular not to the rotatability (pivotability). The fixed arrangement thus preferably causes that a translatory movement (e.g. of the movement element) is prevented in a movement of the handle part, but a rotation (e.g. of the movement element) can take place. Thus, disturbing influence such as shear forces on the handle part can be reliably suppressed for the detection.

It is furthermore conceivable that at least two actuation acquisition elements are provided, which preferably are configured similarly or differently, in order to conduct the detection redundantly, wherein the actuation acquisition elements preferably are oriented towards a single movement element of the movement device. This allows a conduction of reliable verification of errors, in particular ASIL-conform. For example, the actuation acquisition elements can be integrated in a common component, e.g. be used as a common component.

In addition, it can be possible that at least two actuation acquisition elements are provided, which are oriented to different (second) movement elements of the movement device, wherein the (second) movement elements are equally specific to the actuation motion course, and preferably are non-specific to a first motion course, so that the detection of the actuation is possible in a redundant fashion. In other words, in the particular the actuation acquisition element and the (second) movement element is configured redundantly. This allows a further improvement of the error recognition, since mechanical errors, e.g. of the movement elements, are considered.

Likewise subject-matter of the invention is a method for the detection of an actuation in a handle device for a movable part of a vehicle, in particular for opening the movable part, in particular a door or trunk lid or the like, with a movably-mounted handle part and a movement device.

The actuation is e.g. unblocked in the operating position, and includes, in particular a (manual) exertion of force on the handle part, preferably a manual pressing or pulling or the like on the handle part.

It is preferably provided here that the handle part is moved from a resting position to an operating position by means of at least a first motion course of the movement device, and/or the handle part is unblocked for actuation in an operating position, so that an actuation motion course of the movement device occurs upon this actuation.

Preferably, at least one of the following steps is conducted here, preferably successively or in any order, wherein individual steps can, as the case may be, be conducted repetitively:
a) conducting at least one detection, in particular on the movement device, by means of at least one actuation acquisition element to establish an actuation acquisition information,
b) assessing the actuation acquisition information to establish an assessment result, so that the actuation motion course, in particular as a second motion course, is preferably detected based upon the assessment result, in order to detect the actuation of the handle part.

The method according to the invention thus provides the same advantages as have been described in detail with respect to an acquisition system according to the invention and/or a handle device according to the invention. In addition, the method can be suitable to operate an acquisition system according to the invention and/or a handle device according to the invention.

It can be possible that a first acquisition information and the actuation acquisition information as a second acquisition information, is established, which are specific for movements of different movement elements of the movement device, wherein preferably the first acquisition information is specific to a movement of a first movement element and/or the second acquisition information is specific to a movement of a second movement element. This allows e.g. a redundant detecting (in particular e.g. only of the first motion course) and/or an improved error recognition (in particular of the second motion course).

Furthermore, it is advantageous if the actuation motion course as a second motion course can be differentiated from a further motion course, specifically a first motion course, in particular exclusively by means of the assessment of the, specifically first and/or second, acquisition information, which preferably is specific exclusively for a movement of a single, in particular second movement element. The detection is thereby possible in a more reliable manner.

It is furthermore conceivable that in step a), a first detection occurs by means of a comparison acquisition element to establish a first acquisition information, and a second acquisition occurs by means of the actuation acquisition element to establish the actuation acquisition information as a second acquisition information, wherein preferably the first acquisition information is specific to a first motion course, which is different from the actuation motion course, and preferably the first acquisition information is a control information for a drive device to cause the first motion course. This provides the advantage that a particularly reliable detection of the actuation can occur by means of the assessment of different information.

It can be possible that a comparison acquisition element, preferably a first sensor element and/or a control device, is provided for a first movement element of the movement device, in order to establish a first acquisition information, which is specific to a first movement of the first movement element and/or to a first motion course. This allows a redundant and/or reliable detection of the first and/or second motion course and/or of the actuation.

In particular, it can be possible that the acquisition element, in particular the actuation acquisition element and/or the comparison acquisition element, are configured to conduct a contactless detection, in particular measuring, and/or a rotary angle measuring and/or a continuous detecting of a position, in particular of at least one of the (first and/or second) movement elements. Alternatively or additionally, it can be possible by means of the acquisition to detect different positions, specifically rotary angle positions, in particular of the first and/or second movement elements. In other words, it can be possible that not only the final positions, but also intermediate positions of at least one of the movement elements are detected by means of the detection. The position can be detected e.g. continuously, or at least four or six or 10 or 20 or 30 positions for the respective movement element can be differentiated for a respective movement element. In particular, the position of at least one of the movement elements can be detected with a resolution of at least 5° or at least 2° or at least 1° or at least 0.1° by means of at least one of the sensor elements. This achieves the advantage that an especially exact and differentiated acquisition is possible, so that e.g. error states or mechanical deterioration and the like can also be reliably identified. The contactless detecting further allows reduction to the wear during the detection.

Preferably, it can be possible that the actuation detecting element, preferably as a second sensor element, is provided for a second movement element of the movement device, in order to establish a second acquisition information, which is specific for a second movement of the second movement element and/or for the actuation motion course as a second motion course. As a result, further information can be used to improve the detection.

It is also conceivable that a comparison acquisition element, preferably a first sensor element and/or a control device, acts on and/or is oriented towards a first movement element and/or is arranged in the region of the first movement element, so that a first acquisition information of the comparison acquisition element can be assessed, which is specific for a first movement of the first movement element, wherein preferably the actuation acquisition element, preferably a second sensor element, is oriented toward the second movement element, in order to detect a second movement of the second movement element. Thus, detection of the actuation can be improved.

It can, for example, be provided that according to step a), the detection occurs in the movement device, and according to step b), the actuation acquisition information is compared with a control information for a drive device of the movement device, so that the actuation can be detected based upon the comparison, in particular based upon a difference of the movement caused by the drive device and the movement caused by the actuation. Thus, the detection can take place in a simple manner, and the reliability in the detection can be increased.

It is conceivable that the movement device comprises a first movement element, in particular a drive element, and a second movement element, which are moved, in particular similarly, in a first motion course in a first type of movement, and which are moved, in particular differently, in a second motion course, in particular actuation motion course, in a second type of movement, so that the difference of the movement is specific to the actuation of the handle part, and in particular is assessed during the assessing by an assessment device. This allows an improved detection of the actuation.

Furthermore, it can be provided that for an unblocking for the actuation, the handle part is moved according to a first movement from a resting position to the operating position, and preferably for conducting the actuation is moved according to a second movement from the operating position to an actuation position, wherein preferably the first movement is conducted automatically, in particular by means of a drive device, and the second movement is conducted at least partially manually, so that a first motion course of the movement device in the first movement is different from a second motion course, in particular actuation motion course, of the movement device in the second movement. As a result, it is also possible to reliably differentiate the motion courses by means of a detecting on the movement device, and to thereby make a reliable detection of the actuation possible.

It can be possible that the movement device, in particular in the first and/or second motion course, causes a multi-stage movement, in particular per phase in different directions, of the handle part, wherein preferably a first movement and/or a second movement in the actuation includes a translatory and/or rotational movement. An improvement of the operator convenience, in particular for an actuation, is possible thereby.

It is furthermore conceivable that the detection of the actuation occurs redundantly and/or error-recognition in that a first acquisition information is compared with the actuation acquisition information as a second acquisition information.

It is also optionally conceivable that the movement device causes a movement of the handle part, which includes a translatory and/or rotational movement component. This allows a particularly ergonomic and comfortable actuation of the handle part.

It is naturally also conceivable that merely one single motion course, i.e. in particular the actuation motion course, is provided for the movement device. In other words, it can be possible that a first motion course, in which the handle part is translated from a resting position to an operating position and/or vice versa, is disregarded. Accordingly, it is conceivable that the handle part is in the operating position in the non-actuated state at any time, so that a particularly cost-efficient and comfortable handle device is provided.

The movement device can comprise at least one movement element. The movement element or at least one of the movement elements can e.g. be formed as a part separate from the handle part, or as a part of the handle part. For example, a second movement element can be configured as a shaft, or as a bearing arm or the like, in particular of the handle part. The movement elements can also be configured differently, so that e.g. a first movement element is configured as a rotatable axle or shaft or the like. Of course, the movement elements can also be configured as equal or similar parts (e.g. respectively as shafts on different rotary axles).

The movement element or at least one of the movement elements, in particular the second movement element, possibly also the first movement element, preferably is configured as a movable part of the handle device, which in particular at least partially conducts a rotary and/or pivoting and/or translatory movement and/or is mounted in the handle device for conducting the rotary and/or pivoting and/or translatory movement. As a result, the movement of the handle part can be detected in simple ways and manners, and disturbing influences from outside can be reduced.

In particular, the movement device and/or the (first and/or second) movement element is arranged inside a housing of the handle device, preferably inside the movable part, particularly preferably inside the vehicle frame. Particularly preferably, a seal of the movement device, in particular fluid-tight, is provided, preferably on the housing, so that the movement device, i.e. in particular the first and/or second movement element, is reliably protected from humidity from outside the vehicle.

For example, the (first and/or second) movement element is movably-mounted around a (rotary and/or pivoting) axle, and/or itself forms a rotatable and/or pivotable axle or shaft. For example, the movement element and/or at least one of the movement elements is configured as a rotary trunnion. In particular, the (rotary) axle is a fixed axle in the handle device, preferably fixed in relation to the rotatability and/or displaceability relative to (at least) one detecting element of the handle device.

In the scope of the invention, an acquisition element in particular means the actuation acquisition element and/or a comparison acquisition element, which can be configured e.g. similarly or differently. For example, the actuation acquisition element can be configured as a sensor element, and preferably, the comparison acquisition element can be configured as a control device. Of course, it is likewise possible for both the actuation acquisition element and the comparison acquisition element or even further acquisition elements to respectively be configured as sensor elements, which e.g. are oriented toward different movement elements. The detection can thereby be further improved.

Moreover, it is conceivable that a diagnosis, preferably an ASIL-relevant diagnosis (ASIL—Automotive Safety Integrity Level, in particular according to ISO 26262), in particular of the acquisition system, can be conducted. The diagnosis is, e.g. conducted in such a manner that, based on the diagnosis, a state free of error or a state including error of the handle device or of the acquisition system or of the individual acquisition elements (e.g. sensors) is determinable. To that end, a comparison of detecting values with comparison values preferably occurs, particularly preferably in a redundant fashion. The detecting values can preferably be determined through the first and/or second detecting. The comparison is e.g. arithmetically carried out through a processing unit. The advantage can thusly also be achieved that an ASIL-compliant detection of the actuation is possible. It is in particular provided here to conduct, for risk-minimization, a diagnosis of the functionality of the circuit (i.e. in particular of the mentioned sensor elements). It is in particular thusly made possible to achieve, cost-effectively, a high ASIL-level, i.e. a increased security. Here, preferably a drive device, in particular a motor, preferably a servomotor or a stepper motor, of the handle device can be driven with high volumes, and yet a good and reliable diagnosis can occur.

Here it is preferably possible, that, in a first motion course, the movement device actively moves the handle part (this corresponds to a first motion course and/or a transmission of the movement from the movement device to the handle part, effected through the movement device), in particular longitudinally displaceably, and the movement device is moved through the actuation of the handle part in the actuation motion course, i.e. in particular a second motion course (this corresponds to a second motion course effected through the handle part, in particular through a rotating and/or pivoting movement, and/or a transmission of the movement from the handle part to the movement device). A particularly simple and cost-effective implementation of the acquisition system is thereby possible.

Optionally, it can be possible that a comparison acquisition element is provided, and in particular is configured as a comparison sensor element, and preferably the actuation acquisition element is configured as an actuation sensor element. Preferably, the comparison acquisition element and the actuation acquisition element are configured at a distance from one another, and in particular arranged in the region of different rotary axles. In other words, preferably the comparison acquisition element is arranged in a first region of a first rotary axle, and the actuation acquisition element is arranged in a second region of a second rotary axle. In particular, a detection of a movement of a first movement element occurs by means of the comparison acquisition element, and a detection of a movement of a second movement element is effected by means of the actuation acquisition element. Particularly preferably, the first movement element moves, in particular rotates about the first rotary axle, and/or the second movement element moves, in particular rotates, about the second rotary axle. Preferably, the movement of the first movement element correlates with a first movement of the handle part, in particular in the first motion course, and/or the movement of the second movement element correlates with a second movement of the handle part, in particular in the actuation motion course.

It can further be possible that the movement device includes a first movement element and a second movement element, which elements are at least (or only) coupled with one another (mechanically), in the first motion course, for movement transmission, wherein the comparison acquisition element is oriented towards the first movement element, in order to detect a movement of the first movement element through the first detection, and the actuation acquisition element is oriented towards the second movement element, in order to detect a movement of the second movement element through the second detection. In particular, it can be possible that the first movement element and the second movement element are (mechanically) decoupled from one another in the actuation motion course, in particular the second motion course. This has the advantage that the first motion course can be reliably differentiated from the actuation motion course.

Preferably, the comparison acquisition element conducts the first detection in order to quantitatively sense and/or monitor the movement of the first movement element. Particularly preferably, the actuation acquisition element conducts the second detection in order to quantitatively detect and/or monitor the movement of the second movement element. The first movement element and/or the second movement element are here preferably (translatory) fixedly arrangeable (meant is: stationarily, but rotatable) in a handle device, so that error influences can reliably be avoided.

In addition, it is advantageous, if the comparison acquisition element and the actuation acquisition element are connected with a (in particularly one) assessment device, so that (in particular only) the first motion course of the movement device is assessible, in particularly redundantly and/or identically, by means of the first and second detection through the assessment device, and in particular the first motion course is redundantly monitorable and reviewable, in order to conduct a plausibility check and/or detection of a defective first motion course. In particular, non-plausible working regions can also thusly be detected thereby in that a coupling of the first movement element with the second movement element is assessed in the first motion course. If the first detection here differs from the second detection, and/or the first movement of the first movement element from the second movement of the second movement element, then a defective mechanics and/or electronics can be concluded therefrom. E.g. the movement device may then have suffered damages, so that e.g. a corresponding error message can be initiated. This has the advantage that a damaged state of the movement device and/or of the handle device can securely and reliably be detected. Here, it is conceivable that a test run for functionally checking is automatically conducted by the handle device according to the invention whereby the security is additionally increased.

In particular, “similar” means, with reference to at least two courses, such as the course of the detecting and/or a first and second detection value course, that both courses are specific for an identical process, e.g. for a first motion course. Preferably, similar courses are present, if the courses suggest a same absolute rotary angle, i.e. a quantitatively same rotation without consideration of the sign or rotatory direction. This is in particular true when the movement elements, e.g. as toothed gears or shafts, have the same transmission ratio with respect to the movement of the handle part. In place of the detection of a rotation, force and/or length alteration can also be detectable.

Furthermore, it is optionally possible within the scope of the invention that the actuation acquisition element and/or the comparison acquisition element are configured as similar-type sensors, preferably respectively as rotary sensor (rotational sensor), preferably as magnetic sensor, e.g. as Hall sensor. In particular, a rotation of the movement elements can be detected in a simple manner. It is also advantageous if the actuation detecting element and/or the comparison detecting element each comprise multiple sensor means, such as the magnetic sensor, in order to conduct the detection. For example, the sensor means can be arranged at a distance from one another, in order to detect a travel distance of a movement of a lever of the movement element. For example, an indicator, e.g. a magnetic element, is fastened on the lever for this purpose.

It can also be possible that at least one of the detection elements, i.e. e.g. actuation detecting element and/or the comparison detecting element, are configured as at least one of the following sensors:
rotary sensor (rotational sensor), in particular Hall sensor,
rotary-angle-sensor, which is preferably integrated in the drive device,
electric and/or electronic sensor, preferably rotary sensor,
active measuring detector,
passive measuring detector,
capacitive sensor,
mechanical sensor,
piezoelectric sensor,
inductive sensor,
optical sensor,
magnetic sensor (in particular Hall sensor).

In particular, it can be possible that at least one of the acquisition elements is arranged in the region of a mounting place of the handle device, in order to detect a rotary movement and/or pivoting movement and/or a translatory movement.

Likewise, under an “acquisition element”, electric information, e.g. an actuation information, preferably for a motor, preferably a servo motor or a stepper motor, can, in the broader sense, be understood. Thus, it can e.g. be provided, that, in a first detection for establishing a first acquisition information, an actuation signal is assessed as an actuation information for a motor. It can also be possible, that, in a second detection, to establish a second acquisition information, in particular actuation acquisition information, a detection signal, preferably a measuring signal, e.g. of a Hall sensor, is assessed. Of course, it is also possible that both acquisition elements (or also further acquisition elements) are provided, which are configured in a similar manner (e.g. are acquisition actuation signals or measuring signals, respectively).

Preferably, it can be provided that the actuation acquisition element and/or the comparison acquisition element are arranged (e.g. directly and/or immediately and/or rigidly and/or electrically-conductively with conductor paths) on a circuit board, (in particular of the handle device). In particular, the actuation acquisition element and/or the comparison acquisition element are connected, electrically-conductively, with a conductor path and/or with further electronic components (of the handle device). The electronic components include e.g. a processing unit of the handle device. This allows a simple and cost-effective detection.

Preferably, at least one of the movement elements comprises (respectively) a pin element (e.g. a pin, a rod, or the like), wherein the respective movement element preferably is arranged such that the respective pin element plunges into the actuation acquisition element or the comparison acquisition element and/or plunges, respectively, into a mounting element with, respectively, the actuation detecting element or the comparison acquisition element. In particular, the actuation acquisition element and/or the comparison acquisition element are here respectively configured as a Hall sensor element, in order to allow the detection in a particularly dependable and cost-effective manner.

Preferably, the pin element includes at least one magnetic element (magnet element). Thus, a simple and space-saving detection is possible on the respective movement element. Preferably, the actuation detecting element and/or the comparison detecting element is arranged in and/or integrated into a rotary axle for the handle part. The pin element can e.g. also be configured as a pivot trunnion, and preferably be rotatably supported and/or can be pivotable, in particular in the rotary axle.

Preferably, at least one of the movement elements can include a magnetic element. In particular, the magnetic element is arranged on the respective movement element in such a manner that, in a movement of the movement element (a movement of the magnetic element also occurs and) the movement can be detected by means of a change of a magnetic field, wherein, preferably, the magnetic field is generated by the magnetic element. Preferably, a first movement element is here arranged with a first magnetic element in the region of the comparison acquisition element, and a second movement element is arranged with a second magnetic element in the region of the actuation acquisition element. Preferably a first pin element (in particular with the first magnetic element) of the first movement element is plunged into the comparison acquisition element. Particularly preferably, a second pin element (in particular with the second magnetic element), of the second movement element, is plunged into the actuation acquisition element. As a result, a particularly compact and reliable configuration of the handle device is for detection is possible.

Optionally, the respective movement element can at least partially be formed of metal and/or plastic material and/or comprise a ferromagnetic material. In particular, at least one of the movement elements is configured as part of the handle part, preferably co-rotationally and/or non-displaceably fastened to the handle part, particularly preferably monolithically with the handle part. Preferably, the movement element is configured as a rotary axle of the handle part in order to be able to detect the movement in a particularly easy manner.

It is further conceivable that the first motion course and/or the actuation motion course of the movement device can be assessed redundantly and/or similarly through the first and second detection. Here it can in particular be determined a first (temporal) detection value course by means of the first detection, and a second (temporal) detection value course by means of the second detection, which courses are in particular similar. Similar refers e.g. thereto that a determined, absolute rotary angle difference is identical or proportional, wherein e.g. the direction of the rotation can be different. In particular, the second motion course of the movement device is non-redundantly assessible, wherein preferably, in the second motion course, the first detection value course is different from the second detection value course, in particular different in manner (e.g. has a different absolute rotatory angle difference). Preferably, only the second detection value course is specific to the actuation motion course, in particular the second motion course, and the first detection value course is non-specific to the second motion course. This is in particular connected to the fact that, in the second motion course, substantially no rotation of the first movement element occurs. The movement of the first movement element is thereby, in a standstill of the handle part, identical to a movement of the first movement element in the second motion course, that is, if a movement of the handle part occurs. Correspondingly, it cannot be distinguished by means (only) of the first detection value course, if the handle part is in a standstill or moves in a second motion course. The first detection value course is thus non-specific for the second motion course. This, however, has the advantage that, through the comparison of the first detection value course with the second detection value course, the second motion course can be reliably detected. That is because the movement of the second movement element in the second motion course, ascertainable by means of the second detection value course, differs significantly from the movement of the second movement element, in a standstill of the handle part.

It can also be possible that both the first motion course of the movement device and the second motion course of the movement device are redundantly and/or in a similar fashion assessible by the first and the second detection in order to in particular further increase the fail-safety.

It can be possible that the handle part, in a movement from a resting position into an operating position (in particular first operating position) and/or in an actuation position (in particular second operating position), and/or respectively vice versa, conducts at least partially a translatory movement and/or at least partially conducts a rotary movement and/or at least partially a pivoting movement. In other words, the movement of the handle part can have more than one movement component, wherein the translatory movement is effected simultaneously with the rotary movement (and/or pivoting movement), for example. The rotary and/or translatory movement is effected in particular (at least in part) by the movement device. Preferably, the movement device includes at least one pin element (e.g. per movement element), which is preferably guided in respectively one bearing element, e.g. in a rotary bearing and/or is respectively guided in one of the acquisition elements.

In particular, the handle part is displaceably and/or rotatably mounted in the handle device, preferably in the movement device. For example, the movement device and/or the individual movement elements are configured as rotary bearings or similar. Preferably, the handle part is configured as a rotary handle, pull handle or pivot handle, in particular with a bearing axle or guide track. In particular, the handle part is mounted on at least a first and/or second bearing axle. In particular, at least one of the bearing axles is configured as a rotary axle. Preferably, the comparison acquisition element is arranged in the region of the first bearing axle and/or the actuation acquisition element is arranged in the region of the second bearing axle. Preferably, at least one of the bearing axles includes respectively at least one of the movement elements in order to allow the rotation and/or translation be made possible. The bearing axles can here preferably comprise metal and/or plastic material. Preferably, the bearing axle, in particular the movement element, each includes a magnetic element. For detection, the respective magnetic element can preferably be operatively connected with the comparison acquisition element or actuation acquisition element, e.g. plunged therein. Furthermore, one or multiple connecting elements can be provided, which elements connect the respective movement element and/or a respective pin element with the handle part mechanically such that, through a movement of the respective movement element (or pin element), the rotatory and/or translatory movement of the handle part is possible.

Furthermore, it can be optionally possible, that at least one of the movement elements (in particular the first and/or second movement element) respectively comprises at least one magnetic element. The movement elements are respectively movably, preferably rotatably, configured in particular as shafts, or lift bearing or axle or the like. Preferably, the movement elements are respectively configured (substantially) cylindrically and/or circular-cylindrically and preferably include two axial ends. At least one of the movement elements can include, preferably on one of the respective axial ends, in each case one magnetic element. The respective magnetic element includes e.g. a north/south polarity, so that a movement, in particular a rotation of the respective movement element, can reliably be detected by means of an alteration of the magnetic field. Preferably, the detection elements, e.g. as Hall sensors, are arranged in direct proximity or neighboring to the magnetic element, to detect the magnetic field. The detection elements include e.g. the comparison acquisition element, in particular the comparison sensor element (e.g. arranged in the region of a first magnetic element of a first movement element) and the actuation acquisition element, in particular actuation sensor element, (e.g. arranged in the region of a second magnetic element of a second movement element).

It can furthermore also be possible that, by means of the detecting of the respective movements of the movement elements, a motion course of the handle part is determined. Preferably, a first detection of a first movement of the first movement element and a second detection of a second movement of the second movement element are conducted. Preferably, the motion course of the handle part includes different movement phases, which, particularly preferably, can be established and differentiated with one another by means of a qualitative and/or quantitative assessment of the respective detection, and/or by means of a comparison of the respective detections.

Furthermore, it can be possible that, in the movable part, in particular a door, in particular in a door plate, an opening is provided for the handle device, which opening is substantially closed by a recessed grip, and wherein in particular the recessed grip, together with a handle bracket and/or a carrier element, form- and/or force-fittingly secures the handle device in the opening on the door plate. Here, it is in particular conceivable that the at least one—in particular fixed (i.e. in particular translatory fixed or stationary, but rotatable)—movement element and/or the comparison acquisition element and/or the actuation acquisition element are arranged and/or fastened and/or rotatably supported in such a manner, in the handle device, that a distance between the movement element or the comparison acquisition element or the actuation acquisition element, and the recessed grip and/or the handle bracket, remains constant in the first and second motion course. The reliability and susceptibility to inaccuracies is thereby improved for the detection.

Furthermore, it can be advantageous within the scope of the invention, if, in an actuation of the handle part, an electronic signal can be generated, whereby in particular a security system and/or a convenience electronics of the vehicle, can be turned on.

Further advantages, features and details of the invention result from the following description, in which exemplary embodiments of the invention are described in detail with reference to the drawings. Here, the features mentioned in the claims and in the description can in each case each individually or in any combination be essential to the invention. Shown are in:

FIG. 1: a schematic view of parts of an acquisition system according to the invention as well as of a handle device according to the invention;

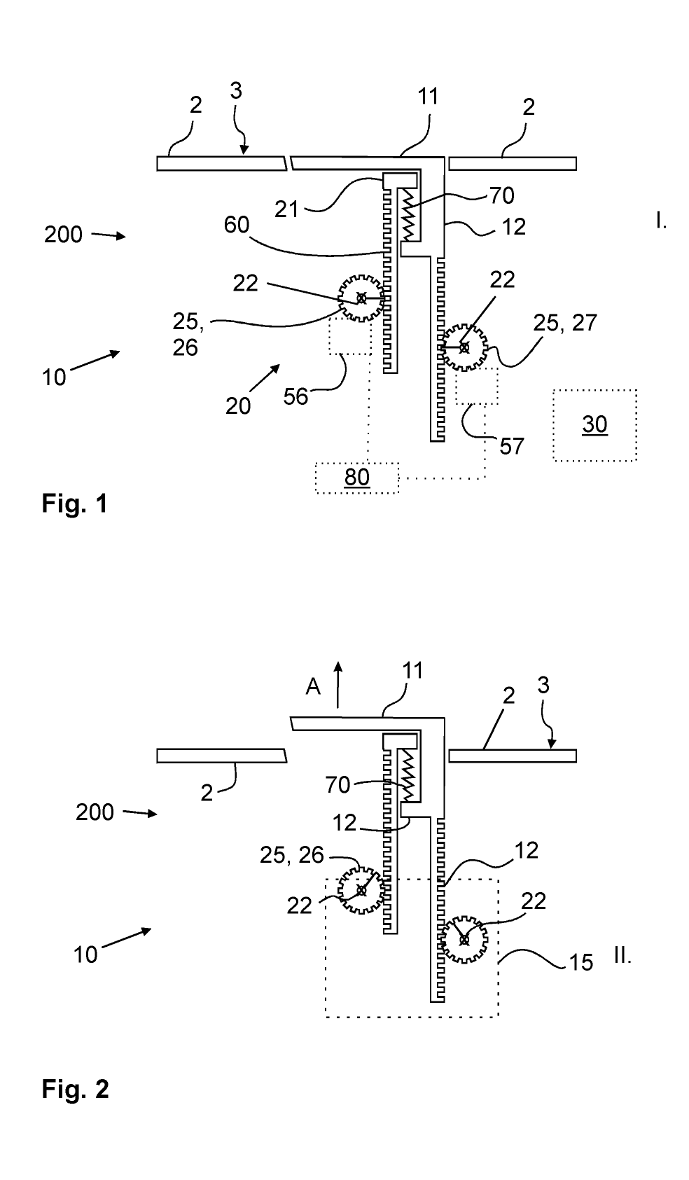

FIG. 2: another schematic illustration of parts of a handle device according to the invention as well as of an acquisition system according to the invention;

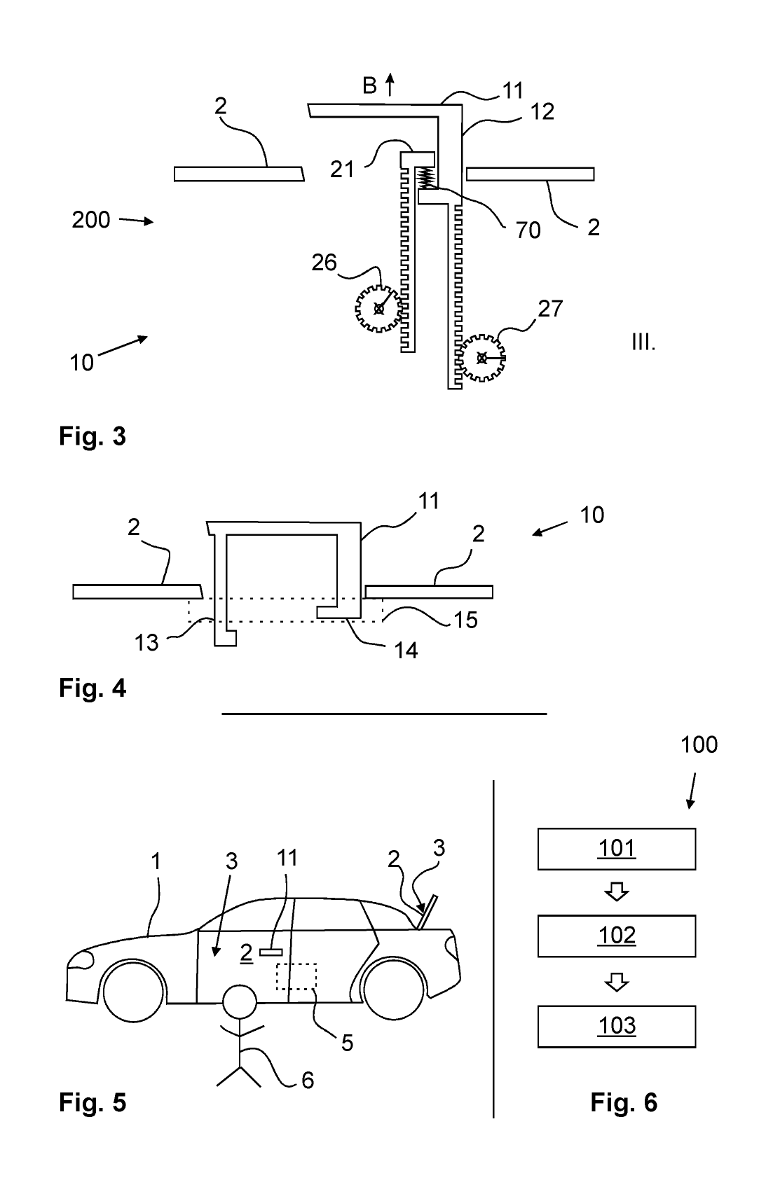

FIG. 3: another schematic illustration of parts of an acquisition system according to the invention as well as of a handle device according to the invention;

FIG. 4: a schematic illustration of parts of a handle device according to the invention;

FIG. 5: a schematic side view on to a vehicle,

FIG. 6: a schematic illustration for the visualization of a method according to the invention;

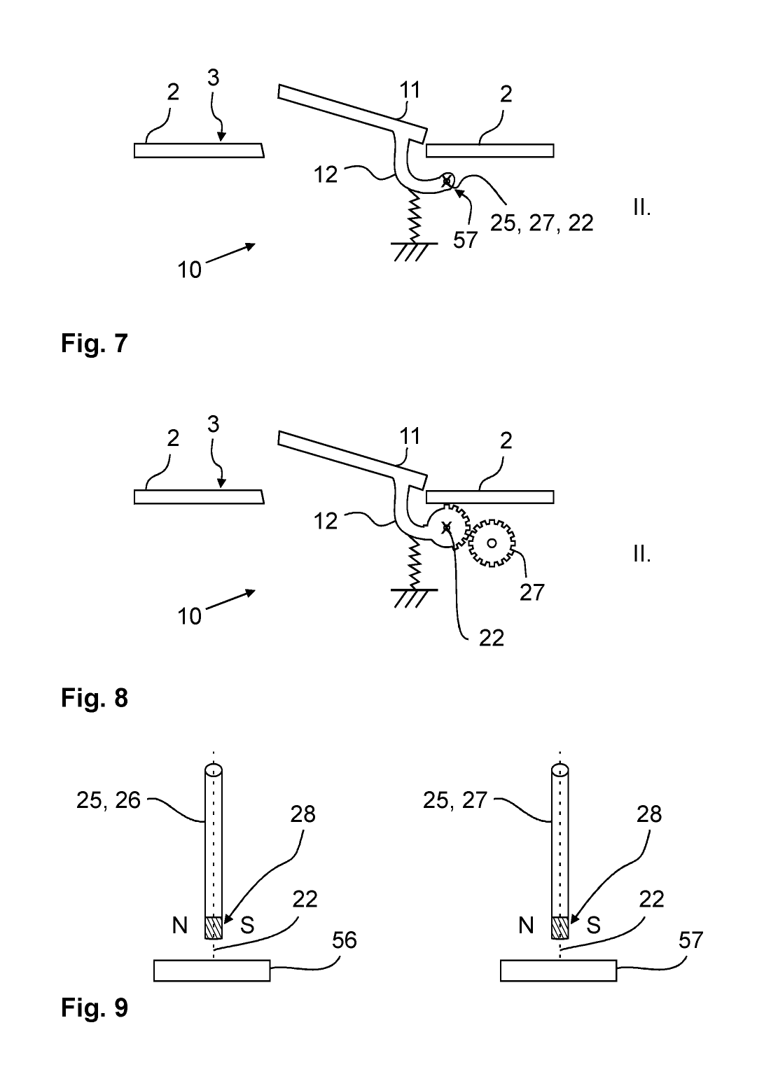

FIG. 7: a schematic illustration of parts of a handle device according to the invention;

FIG. 8: a further schematic illustration of parts of a handle device according to the invention; and

FIGS. 9 to 11: schematic illustrations of movement elements.

In the following Figures, identical reference characters are used for the same technical features even of different exemplary embodiments.

FIGS. 1 to 3 schematically show parts of a handle device 10 according to the invention with an acquisition system 200 according to the invention. Here, FIG. 1 shows a resting position I, FIG. 2 a (first) operating position II, and FIG. 3 shows an actuation position III or (second) operating position III of a handle part 11 of the handle device 10. Furthermore, it is discernible that in the resting position I, the handle part 11 is flush with an outer surface 3 of a movable part 2 of a vehicle 1. An actuation of the handle part 11 by a user 6 is therefore not possible in the resting position I.

Only by a first motion course A of a movement device 20, the handle part 11 is moved from the resting position I into the operating position II, so that the handle part 11 can be actuated manually. This procedure, in particular the triggering of the first motion course A, can e.g. be initiated in a detection of an approach of the user 6 to the vehicle 1. In the Figures, motion courses A, B are illustrated purely schematically by means of an arrow. Of course, only one single motion course (e.g. the actuation motion course B) can be provided. Thus, e.g. a resting position I may not be provided, and this way the handle part 11 can at any time be in the operating position II in the non-actuated state.

In order that the handle part 11 can be moved by means of the first motion course A, the movement device 20 contains at least one movement element 25. This way, a first movement element 26, in particular as an active movement element 26, can directly or indirectly be connected with a drive device 30 or be integrated in the drive device 30. In particular, a movement of the drive device 30 can be transmitted to or by the first movement element 26, which is thereby brought into a rotation, for example. Accordingly, the movement elements 25 can e.g. be configured as gears, or shafts or axles or a lift bearing, which are rotatably supported in the handle device 10. For example, the first movement element 26 is configured as a shaft of the drive device, and the second movement element 27 is configured as a lift bearing. The movement of the first movement element 26 can e.g. be transmitted to a transmission element 60, wherein the transmission element 60 in particular is transferred into a translatory and/or rotational movement. In addition, the transmission element 60 may comprise an actuation region 21, which is in direct operative connection with the handle part 11. The transmission element 60 then pushes against the handle part 11 with the actuation region 21, so that the handle part 11 is moved in the direction of the arrow A from the resting position I into the operating position II.

In addition, the handle part 11 is in operative connection with a second movement element 27, in particular a passive movement element 27, via a handle transmission element 12. In this case, at least one of the movement elements 25 is arranged and/or rotatably mounted on a fixed axle 22, so that the translatory movement of the handle part 11 does not lead to a translatory movement of the movement elements 25. In particular, the movement of the handle part 11 results exclusively in a rotatory movement of the movement elements 25. This way, disturbing influences on the handle part 11, which do not serve an actuation, do not have any disturbing effect on the movement of the movement elements 25. Miscalculation influences can be compensated thereby.

As can in particular be taken from FIG. 4, the movement elements can be arranged on a carrier element 15, in particular mounting carrier 15, of the handle device 10. Preferably, in this case, it can also be possible that a first movement element 26 is arranged on a first bar 13, and a second movement element 27 is arranged on a second bar 14.

It can be taken from FIGS. 1 to 3 that the movement of the movement elements 25 occur similarly in a first motion course A, and differently in an actuation motion course B, in particular second motion course B. This different transmission of the movement of the handle part 11 in the second motion course B allows a particularly reliable and unambiguous detection of the actuation of the handle part 11. This actuation then in particular serves to activate and/or actuate a closing device 5.

In the operating position II, the handle part 11 can be actuated in that a short stroke in the direction of arrow B is carried out on the handle part 11. To that end, a user 6 e.g. pulls on the handle part 11 in the direction away from the movable part 2, as is indicated by arrow B. The handle part 11 is thereby transferred in an actuation position III (c.f. FIG. 3) in order to actuate the handle device 10.

It can be possible that the handle part 11 can conduct exclusively the movement from the operating position II to the actuation position III, and thus merely the actuation motion course B is provided. Alternatively, besides the actuation motion course B as a second motion course B, also a first motion course A can be additionally provided, in order to transfer the handle part 11 to the operating position II. Accordingly, the actuation motion course B, or the second motion course B, serves to translate the handle part 11 from the operating position II to the operating position III. In particular, the actuation motion course B is e.g. (primarily) transmitted only to the second movement element 27 owing to a decoupling element 70. In other words, in the second motion course B, a transmission of the movement between the handle part 11 and the movement elements 25 different from that in the first motion course A occurs. To that end, the decoupling element 70 is in particular configured as a spring, which is able to absorb the kinetic energy of the handle part 11 from the movement from the operating position II to the actuation position III.

FIG. 5 shows that the handle part 11 can be configured for opening of a movable part 2. The movable part 2 can in particular be formed as a door and/or as a trunk lid of the vehicle 1. Of course, the handle part 11 can therefore likewise be arranged on the trunk lid, or on another part of the vehicle 1.

A method 100 according to the invention is schematically illustrated according to FIG. 6. According to a first method step 101, a first detecting is conducted through at least one comparison acquisition element 56 for establishing a first acquisition information. According to a second method step 102, a second detecting is conducted through at least one actuation acquisition element 57 for establishing a second acquisition information, in particular actuation acquisition information. According to a third method step 103, a comparison of the first acquisition information with the second acquisition information is conducted for establishing a comparison result, so that by means of the comparison, the actuation motion course B can be detected, in order to detect the actuation of the handle part 11.

As can be taken from FIG. 1, the comparison acquisition element 56 can be arranged in the region of the first movement element 26, and the actuation acquisition g element 57 can be arranged in the region of the second movement element 27. For this purpose, the comparison acquisition element 56 is e.g. configured as a control device for the first movement element 26, wherein the first movement element 26 is configured e.g. as a (drive) shaft of a drive device 30. The actuation acquisition element 57 is e.g. configured as an (actuation) sensor element and/or oriented towards the second movement element 27. The first and second acquisition can in this case be assessed by an assessment device 80, for example, which is connected with the acquisition elements, in particularly electrically. Of course, it can also be possible that only the actuation acquisition element is provided without the comparison acquisition element, and thus merely the second detecting, or only the establishing of the actuation acquisition information, is conducted.

FIGS. 7 and 8 schematically show parts of a handle device 10 according to the invention. It can be seen here that the handle part 11 is formed as a rotary handle 11, which is rotatably mounted about a rotary axle 22. In the movement from the operating position II to the actuation position III, it can be possible for the handle part 11 to conduct a rotational movement (and/or pivoting movement) or a translatory movement, together with a rotational movement (and/or pivoting movement). This movement e.g. is caused by the movement device 20. It is possible here that the handle part is exclusively movable from the operating position II to the actuation position III, and/or vice versa, so that no resting position I is provided. Alternatively, a movement from the resting position I to the operating position II can additionally be possible, e.g. automatically and/or as a rotational and/or translatory movement.

Furthermore, it can be possible, according to FIG. 7, that a movement element 25, respectively the second movement element 27, is integrated in the rotary axle 22. In the region of or on the rotary axle 22, in particular of a bearing axle, a magnetic element 28 can preferably be attached. The magnetic element 28 is in particular arranged on a (e.g. first or second or single) movement element 25. The magnetic element 28 can e.g. serve to be detected by the actuation acquisition element 57. Here, the actuation acquisition element 57 can likewise be integrated in the rotary axle 22 and/or be arranged in the region of the rotary axle 22, preferably in a magnetic field of the magnetic element 28. It can also be possible that the movement element 25 or the second movement element 27 is configured as a bearing arm of the handle part 11.

Preferably, a handle part axle 23 is provided, around which the handle part 11 is moved in the actuation motion course B, in particular rotated and/or pivoted. In FIG. 7, a handle part axle 23 corresponds to the rotary axle 22, around which the movement element 25, or the second movement element 27, moves, in particular rotates and/or pivots.

FIG. 8 shows another option for the configuration of the handle device 10 according to the invention. It can be seen here that (e.g. a second or single) movement element 25, 27 is provided. In particular, a rotary axle 22, around which the (e.g. second or single) movement element 25, 27 moves, is arranged at a distance from a handle part axle 23. Preferably, the (second) movement element 25, 27 is in operative connection with a handle transmission element 12 in such a way, that at least a rotary movement of the handle part 11 is transmitted to the (second) movement element 25, 27. For example, the (second or single) movement element 25, 27 and/or the handle transmission element 12 is at least in part and/or at least in sections configured as a gear-mechanism element. In particular, an actuation acquisition element 57 is oriented towards the (e.g. second or single) movement element 25, 27.

FIG. 9 schematically shows a first movement element 26 and a second movement element 27. Of course, further movement elements 25 can be provided, which are formed in such a way or in a similar way. It can also be possible that only one of the shown movement elements 25 is provided. The movement element 25, or the movement elements 25, is/are configured e.g. cylindrically and/or in each case include a magnetic element 28, which preferably has a north (N) and south (S) polarity (illustrated schematically). Thus, a magnetic field can be generated, which is specific for a movement of the respective movement element 25. A acquisition element, in particular a sensor element (i.e. a comparison acquisition element 56 or an actuation acquisition element 57) can be arranged in the magnetic field, for the, in particular continuous, detecting of the rotation of the movement elements 25 by a rotation of the magnetic elements 28.

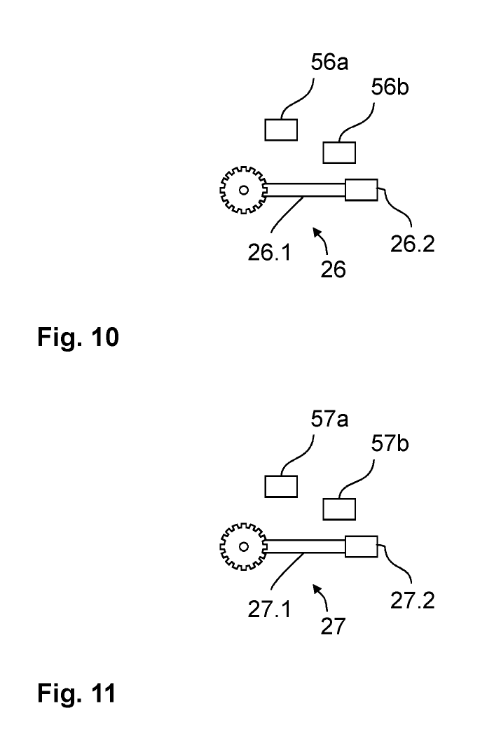

FIG. 10 shows that the first movement element 26 may comprise a lever 26.1, and that e.g. the comparison acquisition element 56 comprises at least two sensor means 56a, 56b. According to one advantage, the sensor means 56a, 56b can be arranged at a distance, in order to detect a travel distance of a movement of the lever 26.1. To that end, an indicator, such as a magnetic element 26.2, can be fastened on the lever 26.1, the approaching of which can be detected by the sensor means 56a, 56b.

As an alternative or in addition, the second movement element 27 can also comprise a lever 27.1, as is illustrated in FIG. 11. Here, the actuation acquisition element 57 can comprise at least two sensor means 57a, 57b, which can detect the movement of an indicator, such as a magnetic element 27.2, on the lever 27.1. This likewise allows a path distance measurement at the lever 27.1, to this way detect the rotary movement.

The above explanation of the embodiments describes the present invention exclusively by way of examples. It goes without saying that individual features of the embodiments, insofar as they are technically reasonable, can freely be combined with one another, without departing from the scope of the present invention.

### LIST OF REFERENCE CHARACTERS

1 vehicle
2 movable part, door, trunk lid
3 outer surface
5 closing device
6 user
10 handle device
11 handle part
12 handle transmission element
13 first bar
14 second bar
15 carrier element, mounting carrier
20 movement device
21 actuation region
22 axle, rotary axle
23 handle part axle
25 movement element, gear, shaft
26 first movement element, active movement element
26.1 lever of 26
26.2 magnetic element of 26
27 second movement element, passive movement element
27.1 lever of 27
27.2 magnetic element of 27
28 magnetic element
30 drive device
55 sensor element
56 comparison acquisition element, first sensor element
56a first sensor means of 56
56b second sensor means of 56
57 actuation acquisition element, second sensor element
57a first sensor means of 57
57b second sensor means of 57
60 transmission element
70 decoupling element
80 assessment device
100 method
200 acquisition system
A first motion course
B actuation motion course, second motion course
resting position
II operating position
III actuation position
N north
S south

1. An acquisition system for the detection of an actuation in a handle device of a vehicle, comprising a movement device, which in a movement of a handle part of the handle device can be brought into at least one actuation motion course,
wherein
at least one actuation acquisition element is arranged on the movement device, so that the actuation motion course can be assessed by a detection of the actuation acquisition element, whereby the actuation is detectable.

2. The acquisition system according to claim 1,
wherein
the movement device comprises at least one movement element, which is movable around a rotary axle, whereby the movement of the movement element can be detected by means of the actuation acquisition element, wherein preferably the rotary axle corresponds to a handle part axle or is configured spaced from the handle part axle, wherein preferably the movement of the movement element depends on the movement of the handle part.

3. The acquisition system according to claim 1,
wherein
the actuation acquisition element is arranged in the region of a rotary axle, and is oriented towards at least one movement element of the movement device in order to detect a movement of the movement element, wherein preferably the movement of the movement element is specific to the actuation motion course, and the actuation motion course is at least partially specific to the actuation in the handle device.

4. The acquisition system according to claim 1,
wherein
the movement device can be brought into a multi-stage motion course, wherein the movement device can be brought into a first motion course for the transfer of the handle part from a resting position to an operating position, and after conducting the first motion course, can be brought into the actuation motion course as a second motion course, wherein at least the second motion course can be assessed by the detection of the actuation acquisition element.

5. A handle device for a movable part of a vehicle, comprising a movably-mounted handle part and a movement device, wherein
the handle part is manually actuatable in an operating position, so that upon actuation, at least one actuation motion course of the movement device occurs,
wherein
at least one actuation acquisition element is arranged on the movement device, so that the actuation motion course can be assessed by a detection of the actuation acquisition element, whereby the actuation is detectable.

6. The handle device according to claim 5,
wherein
the movement device comprises at least one movement element, wherein at least one of the movement elements is configured as one of the following elements:
a movably-mounted, preferably at least rotatably or pivotably-mounted bearing element,
a rotatably-mounted element, on a fixed axle of the movement device,
a rotatably-mounted shaft,
a drive element, preferably of a drive device.

7. The handle device according to claim 5,
wherein
besides the actuation motion course as a second motion course, yet a first motion course of the movement device upstream the second motion course, is provided, so that upon the actuation, only the second motion course of the movement device occurs, and the first motion course can be differentiated from the second motion course by means of the sensing.

8. The handle device according to claim 5,
wherein
the movement device includes a drive device for the handle part, wherein a first movement can be transmitted by the drive device to the handle part, so that a first motion course of the movement device occurs, which is different from the actuation motion course.

9. The handle device according to claim 5,
wherein
a movement element is connected with the handle part at least in a rigid or co-rotational or non-displaceable manner or in one piece or monolithically.

10. The handle device according to claim 5,
wherein
at least a drive device or a first movement element is connected with the handle part for the transmission of force at least only in a first motion course or exclusively at least form or force-fittingly, wherein the first motion course differs from the actuation motion course.

11. The handle device according to claim 5,
wherein
a comparison acquisition element is provided, which is configured as a control device for a drive device for causing a first motion course, so that based upon in particular a comparison of a first acquisition information of the comparison acquisition element and a second acquisition information of the actuation acquisition element, at least the first motion course or the actuation motion course can be assessed.

12. The handle device according to claim 5,
wherein
the movement device comprises a drive device, wherein the drive device comprises at least a first movement element, so that a drive movement occurs by the first movement element, and can be transmitted to the handle part as a first movement in a first motion course, and indirectly, can be transmitted to a second movement element of the movement device.

13. The handle device according to claim 5,
wherein
at least one movement element of the movement device is provided, and is respectively formed as a translatory-fixed part of the handle device, so that a translatory movement of the movement element is essentially prevented by the movement of the handle part.

14. The handle device according to claim 5, wherein
an acquisition system for the detection of an actuation in a handle device of a vehicle, comprising a movement device, which in a movement of a handle part of the handle device can be brought into at least one actuation motion course,
wherein
at least one actuation acquisition element is arranged on the movement device, so that the actuation motion course can be assessed by a detection of the actuation acquisition element, whereby the actuation is detectable is provided.

15. A method for the detection of an actuation in a handle device for a movable part of a vehicle, comprising a movably-mounted handle part and a movement device, wherein
the handle part, in an operating position, is unblocked for actuation, so that upon said actuation, an actuation motion course of the movement device occurs,
characterized by the following steps:
a) conducting at least one detecting by means of at least one actuation acquisition element to establish an actuation acquisition information,
b) assessing the actuation acquisition information to establish an assessment result, so that the actuation motion course is detected in order to detect the actuation of the handle part.

16. The method according to claim 15,
wherein
in step a), a first detection to establish a first acquisition information is effected by a comparison acquisition element, and a second detection to establish the actuation acquisition information as a second acquisition information is effected by the actuation acquisition element, wherein preferably the first acquisition information is specific to a first motion course, which is different from the actuation motion course, and preferably the first acquisition information is a control information for a drive device for causing the first motion course.

17. The method according to claim 15,
wherein
according to step a), the detection occurs at the movement device and according to step b), the actuation acquisition information is compared with a control information for a drive device of the movement device, so that the actuation is detected by means of the comparison.

18. The method according to claim 15, wherein
for an unblocking for the actuation, the handle part is moved according to a first movement from a resting position to the operating position, and for the conducting of the actuation, is moved according to a second movement from the operating position to an actuation position, wherein preferably the first movement is conducted automatically, and the second movement is conducted at least partly manually, so that a first motion course of the movement device in the first movement differs from a second motion course, of the movement device in the second movement.

19. The method according to claim 15,
wherein
the movement device causes a movement of the handle part, which includes at least a translatory or rotary movement component.

20. The method according to claim 15, wherein
at least an acquisition system for the detection of an actuation in a handle device of a vehicle, comprising a movement device, which in a movement of a handle part of the handle device can be brought into at least one actuation motion course, wherein at least one actuation acquisition element is arranged on the movement device, so that the actuation motion course can be assessed by a detection of the actuation acquisition element, whereby the actuation is detectable or
a handle device for a movable part of a vehicle comprising a movably-mounted handle part and a movement device, wherein the handle part is manually actuatable in an operating position, so that upon actuation, at least one actuation motion course of the movement device occurs, wherein at least one actuation acquisition element is arranged on the movement device, so that the actuation motion course can be assessed by a detection of the actuation acquisition element, whereby the actuation is detectable, is operable.
